(19) United States
(12) Patent Application Publication
(10) Pub. No.: US 2007/0133926 A1
(43) Pub. Date: Jun. 14, 2007

(54) Flexible cam member for fiber optic mechanical splice connector

(76) Inventors: Scott E. Semmler, Keller, TX (US); Brandon A. Barnes, Ft. Worth, TX (US)

Correspondence Address: CORNING CABLE SYSTEMS LLC, P O BOX 489, HICKORY, NC, 28603, US

(21) Appl. No.: 11/301,897

(22) Filed: Dec. 13, 2005

(51) Int. Cl. G02B 6/38

(52) U.S. Cl. 385/72; 385/53; 385/54; 385/55; 385/56; 385/60; 385/70; 385/75; 385/134

(57) ABSTRACT

A cam member having a specific interior geometry for applying a force to alignment components of a mechanical splice fiber optic connector. A cam member defining an interior surface having a decreasing diameter transition from a cam member un-actuated position to an actuated position without an intermediate position having a diameter greater than the actuated position diameter. A cam member defining an un-actuated diameter and an actuated diameter, wherein the un-actuated diameter is greater than the actuated diameter in both un-actuated and actuated positions of the cam member. A flexible and resilient cam member for use in a fiber optic connector that maintains specific diametral relationships while maintaining a splice force.

### BACKGROUND OF THE INVENTION

1. Field of the Invention

The present invention relates generally to fiber optic connectors, and more specifically, to a flexible cam member for a mechanical splice fiber optic connector having a specific geometry for applying an alignment force to optical fiber splice components of the fiber optic connector.

2. Technical Background

One of the key objectives contributing to the proper function of a mechanical splice fiber optic connector is the alignment of the optical fibers within the connector. This is typically accomplished by applying a force to one or more splice components of the fiber optic connector in order to effectively align and retain the optical fibers. Conventional mechanical splice connectors typically include a first splice component defining a v-groove, and a second complimentary, generally flat splice component. The mating optical fibers are typically held within the v-groove of the first splice component by the second complimentary splice component. These splice components are typically commonly held within a housing cavity, or ferrule holder, that houses the connector ferrule and other splice parts. A rib or keel typically extends from one of the splice components through a passageway in the ferrule holder. A cam member defining an internal geometry is typically housed over the splice components and the ferrule holder. In an un-actuated position, a larger diameter of the cam member is located off of the keel, thus applying minimal or no interference with the keel. When the cam member is rotated and actuated, a smaller diameter of the cam member preferably contacts and applies a force on the keel, thus pressing the splice components together and aligning the optical fibers.

Referring to prior art FIGS. 1A-1B, one example of a conventional cam member of a fiber optic mechanical splice connector having a specific internal geometry is shown. The conventional mechanical splice connector is described in U.S. Pat. No. 4,923,274 and is available from Corning Cable Systems of Hickory, N.C. FIG. 1A illustrates the cam member 20 in an un-actuated position. The cam member 20 is positioned about a ferrule holder 22. The ferrule holder 22 houses a first splice component 24 and a second splice component 26. The first splice component 24 defines a keel 28 and a v-groove 30, while the second splice component defines a generally flat surface 32. The internal geometry of the cam member 20 is used to apply an alignment force to the fiber alignment components. The internal geometry of the cam member 20 includes three notable internal dimensions. In the un-actuated position, the largest cam circumferential dimension D1 is positioned over the keel 28 as to not apply force to the keel 28, thus allowing the optical fibers to be inserted into the connector. During actuation, the cam circumferential dimension decreases to apply force to the splice keel 28. The intermediate circumferential dimension is illustrated at D2. The cam member 20 defines a third circumferential dimension D3, which is positioned over the keel 28 when the cam member 20 is in the fully actuated position. As is shown in FIG. 1A, D1 is greater than D2, which is greater than D3 (i.e., D1>D2>D3).

FIG. 1B illustrates the cam member 20 rotated in the clockwise direction into the fully actuated or functional position. In the actuated position, the third circumferential dimension D3-a is smaller than the starting circumferential dimension D1-a, but larger than the intermediate circumferential dimension D2-a. This actuated dimension D3-amay operate as a locking feature to help maintain the cam member 20 in the functional position. When the cam member 20 is rotated to the functional position, force is applied to the splice keel 28. The resistance between the keel 28 and the internal surface of the cam member 20 causes the cam member 20 to flex at the position where the width of the cam member 20 is in-line with the splice keel 28. Thus, comparing FIG. 1B to FIG. 1A, the width of the cam member 20 along the Y-axis increases, resulting in the diameter Y1-a being greater than the diameter Y1, and the diameter X1 being greater than the diameter X1a. In other words, Y1-a is greater than the width of the cam member 20 in-line with the keel 28 in the un-actuated position as shown in FIG. 1A at Y1. Thus, the flexing of the cam member 20 results in an altered configuration of the cam member internal dimensions in the actuated or functional position. The resulting intermediate distance FIG. 1B at D2-a located between the initial position FIG. 1B at D1-a and the final position FIG. 1B at D3-a is smaller than both the initial and final positions. Further, D1-a is greater than D3-a, which is greater than D2-a (i.e., D1-a>D3-a>D2-a), as described in the U.S. Pat. No. 4,923,274.

While one example of a cam member, cam member internal geometry and the resulting internal geometry after cam member actuation is shown and has been described above, the described cam member having the specific internal geometry is not the only design for applying a force to the splice components and aligning the optical fibers in a mechanical splice fiber optic connector. Accordingly, what is desired is an alternative cam member design and camming method for maintaining splice force in a mechanical splice fiber optic connector. It would also be desirable to provide a cam member that maintains splice force while also maintaining the specific internal geometry of the cam member during actuation and positioning of the cam member into the functional position. It would further be desirable to maintain the cam member in the functional position by the interference of the splice components and the flexing of the cam member, which creates a spring force or stored energy, helping to hold the connector in an actuated position, and accommodating any differences in expansion of the connector materials while undergoing temperature changes.

### SUMMARY OF THE INVENTION

In one aspect, the present invention is directed to a cam member of a mechanical splice connector, wherein the cam member functions to place a force upon splice components as the cam member is moved between an un-actuated and an actuated position. The cam member preferably functions to apply a force to splice components of the fiber optic connector in order to effectively align optical fibers. The cam member preferably maintains the splice force while maintaining dimensional relationships and geometry of the cam member internal features.

In another aspect, the present invention is directed to a cam member of a mechanical splice connector, wherein the cam member defines a specific geometry for applying an alignment force to optical fiber splice components of the connector. In a preferred embodiment, when the cam member is in an un-actuated position, the cam member defines three internal dimensions: a first dimension that is aligned with but does not interfere with a keel of a splice component; a second intermediate dimension that is smaller than the first dimension; and a third dimension that is smaller than the second intermediate dimension, and wherein the third dimension is in contact with the keel when the cam member is moved or rotated to an actuated or functional position. In the actuated position, the cam member maintains the internal dimensional relationships where the first dimension is greater than the second dimension, and the second dimension is greater than the third dimension. Preferably, when the cam member is in an actuated position, the largest dimension is significantly larger than the intermediate dimension, and the intermediate dimension is larger than the activated dimension. In the actuated or functional position, the cam member may flex where the cam member is in line with the splice keel, thus resulting in a lengthening of the cam member along one axis (e.g., y-axis) and a shortening of the cam member along another axis (e.g., x-axis), while maintaining the relationships between the three dimensions. In other words, although the cam member flexes during actuation, the first dimension preferably remains larger than the second intermediate dimension, and the second intermediate dimension preferably remains larger than the third functional position dimension. In an alternative embodiment, in the actuated position, the second intermediate dimension may be equal to the third functional position dimension. Maintaining the cam member in the functional position is achieved by both the interference of the components, along with the flexing of the cam member which creates spring force or stored energy, helping to hold the assembly in the closed position, and accommodating any differences in expansion of the assembly materials while undergoing temperature changes.

In yet another aspect, the present invention is directed to a cam member of a mechanical splice connector, wherein the cam member defines an un-actuated dimension and an actuated dimension, and wherein the actuated dimension has a smaller diameter than the un-actuated dimension in both un-actuated and actuated positions of the cam member. The cam member may also define an intermediate dimension positioned between the un-actuated and the actuated dimensions having a diameter greater than un-actuated dimension and the actuated dimension. The cam member may be flexible or rigid. The cam member may be resilient and/or deformable. In an exemplary mechanical splice connector, the un-actuated dimension is positioned off of a keel of a splice component when the cam member is in the un-actuated position. As the cam member is rotated or moved to the actuated position, the intermediate dimension passes over the keel. In the fully actuated position, the actuated position is in line with the keel and the keel interferes with the interior surface of the cam member. The fully actuated position is also referred to herein as the “locked position.” In other embodiments, the un-actuated dimension and the actuated dimension have diameters that vary in size relative to each other, so long as the actuated dimension maintains the smallest diameter of the cam member in both un-actuated and actuated positions of the cam member.

In a still further aspect, the present invention is directed to a cam member of a mechanical splice connector, wherein the mechanical splice connector includes one or more splice components. In connector embodiments including two splice components, a first splice component preferably defines a keel on one side of the component and a v-groove on the other side of the component. The keel is operable for contacting an inner surface of the cam member as the cam member is moved or rotated from an un-actuated position to an actuated position in order to hold the cam member in the actuated or locked position. The v-groove is operable for seating and aligning mating optical fibers inserted into the connector. A second splice component defines a flat surface. The first and second splice components are preferably commonly held within a housing cavity or ferrule holder, which houses the connector ferrule and splice parts. The keel preferably extends from the first splice component through a passageway in the ferrule holder. The cam member defines a specific internal geometry and is positioned over the splice components and the ferrule holder. As the cam member is positioned in the un-actuated position, a larger diameter of the cam member is positioned off of the keel, thus applying minimal or no interference with the keel. As the cam member is rotated into the actuated position, the internal diameter of the cam member decreases and the inner surface of the cam member contacts and applies a force to the keel, thus pressing the splice components together and aligning and securing the mating optical fibers. In an alternative embodiment, the first splice component may define a flat surface while the second splice component without the keel defines a v-groove or alternatively shaped channel for receiving and seating the mating optical fibers.

In a still further aspect, the present invention is directed to a mechanical splice connector for interconnecting optical fibers. In one example, the optical fibers include a stub optical fiber of the mechanical splice connector and a field optical fiber. The optical fibers are brought into optical contact within the connector and held in place by one or more splice components within the connector. In preferred embodiments, the field optical fiber is inserted into the one end of the connector such that the optical fiber is positioned between splice components and aligned with the stub optical fiber. Once the optical fibers are properly positioned within the splice components, a cam member of the connector is rotated to an actuated or functional position, securing the optical fibers within the connector. Preferably, the internal surface of the cam member applies a force to a keel or feature of one of the splice components, thus pressing the splice components together and holding the optical fibers between. The cam member may be designed such that it may be rotated by hand or by a tool. The cam member preferably defines three internal dimensions: a first dimension that is aligned with but does not interfere with the keel of the splice component; a second intermediate dimension that is smaller than the first dimension; and a third dimension that is smaller than the second intermediate dimension, and wherein the third dimension is in contact with the keel when the cam member is rotated to the actuated or functional position. In both un-actuated and actuated positions, the cam member maintains the internal dimensional relationships where the first dimension is greater than the second dimension, and the second dimension is greater than the third dimension. Preferably, when the cam member is in an actuated position, the largest dimension is significantly larger than the intermediate dimension, and the intermediate dimension is larger than the activated dimension. In the actuated or functional position, the cam member may flex where the cam member is in line with the splice keel, thus resulting in a lengthening of the cam member along one axis (e.g., y-axis) and a shortening of the cam member along another axis (e.g., x-axis). Maintaining the cam member in the functional position is achieved by both the interference of the components, along with the flexing of the cam member that creates spring force or stored energy, helping to hold the cam member in the functional position.

In other aspects, the external features of the cam member may be cylindrical or may include other application specific shapes (e.g., rectangular) in order to accommodate product size. The cam member is preferably flexible in order to provide spring force to assist in holding the assembly in the functional position. However, the cam member may also be rigid, relying on component interference to hold the splice components in the functional position. In preferred embodiments, the cam member defines internal features and has the ability to maintain a smooth transition from the largest dimension in the un-actuated position to the smallest dimension in the actuated position, without passing through a yet smaller intermediate position.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be illustrative and not limiting.

### BRIEF DESCRIPTION OF THE DRAWINGS

FIG. 1A is a cross-sectional view of a prior art cam member of a conventional fiber optic connector shown in an un-actuated position;

FIG. 1B is a cross-sectional view of the prior art cam member of FIG. 1A shown in an actuated or functional position;

FIG. 2A is a lengthwise cross-sectional view of a field optical fiber being inserted into a conventional mechanical splice fiber optic connector including a cam member for maintaining splice force;

FIG. 2B is a lengthwise cross-sectional view of the connector of FIG. 2A showing the field optical fiber fully inserted and the cam member rotated to the actuated or functional position;

FIG. 3A is a cross-sectional view of a cam assembly of the fiber optic connector of FIG. 2A taken along line 3A-3A and shown with the cam member in an un-actuated position; and

FIG. 3B is a cross-sectional view of a cam assembly of the fiber optic connector of FIG. 2B taken along line 3B-3B and shown with the cam member in an actuated or functional position.

### DETAILED DESCRIPTION OF THE PREFERRED EMBODIMENTS

Reference will now be made in detail to the present preferred embodiments of the invention, and examples of which are illustrated in the accompanying drawings. Whenever possible, the same reference numerals will be used throughout the drawings to refer to the same or like parts. While a cam member having a specific geometry is shown in the various figures as a component of an exemplary mechanical splice fiber optic connector, it is envisioned that the cam member may be a component of any now known or hereafter devised fiber optic connector for interconnecting optical fibers while achieving the advantages described in the present invention.

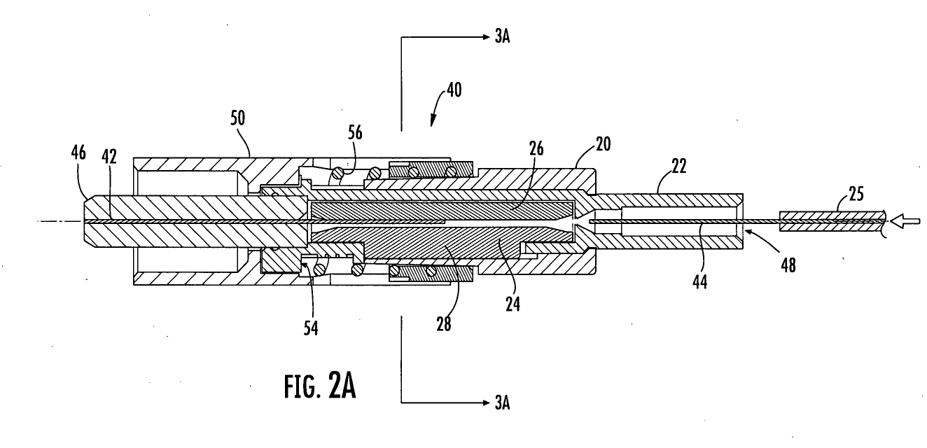

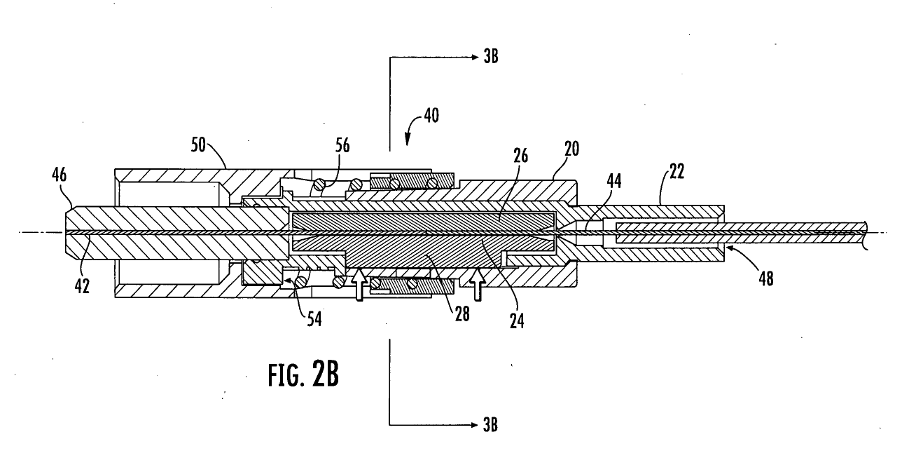

Referring now to FIG. 2A, a mechanical splice fiber optic connector 40 is shown and includes a cam member 20 having a specific geometry to apply an alignment force to splice components of the fiber optic connector 40. The fiber optic connector 40 is operable for optically connecting optical fibers. As shown, the optical fibers include a stub optical fiber 42 of the mechanical splice connector 40 and a field optical fiber 44. At one end, the stub optical fiber 42 terminates in a ferrule 46. At the other end, the stub optical fiber 42 is prepared for optical connection with the field optical fiber 44. The optical fibers are brought into optical contact within the connector 40 and held in place by one or more splice components within the connector 40. The field optical fiber 44 is shown being inserted into the one end of the connector 40 through a lead-in channel 48 defined by a ferrule holder 22. In an alternative embodiment, the field optical fiber 44 may be inserted into a lead-in tube (not shown) retained within the lead-in channel 48. The ferrule holder 22 and underlying components are retained within an inner housing 50. The ferrule holder 22 defines flats 54, or stops, for seating a spring 56 operable for biasing the ferrule 46 and the ferrule holder 22.

The connector 40 includes a first splice component 24 and a second splice component 26. The first splice component 24 preferably defines a keel 28 about one side of the component and a v-groove, or other shaped channel, about the other side of the component 24. The keel 28 is operable for contacting an inner surface of the cam member 20 as the cam member 20 is rotated from an un-actuated position to an actuated position in order to hold the cam member 20 in the actuated or locked position. The v-groove is operable for seating and aligning mating optical fibers inserted into the connector 40. The second splice component 26 defines a flat surface that opposes the v-groove or other shaped channel on the first splice component 24 that maintains the mating optical fibers in the v-groove as the splice components are pressed together during actuation. The first and second splice components 24, 26 are preferably commonly held within the ferrule holder 22. In an alternative embodiment, the splice components 24, 26 may be commonly held within an interior cavity of the connector 40. The keel 28 preferably extends from the first splice component 24 through a passageway in the ferrule holder 22. The cam member 20 defines a specific internal geometry and is positioned over the splice components and the ferrule holder 22. As the cam member 20 is positioned in the un-actuated position as is shown in FIG. 2A, a larger interior diameter of the cam member 20 is positioned off of the keel 28, thus applying minimal or no interference with the keel 28. As the cam member 20 is rotated into the actuated position as is shown in FIG. 2B, the internal diameter of the cam member 20 gradually decreases and the inner surface of the cam member 20 contacts and applies a force to the keel 28, thus pressing the splice components 24, 26 together and aligning and maintaining the mating optical fibers. In an alternative embodiment, the first splice component 24 may define a flat surface while the second splice component 26 defines a v-groove or alternatively shaped channel for receiving and maintaining the mating optical fibers. The cam member 20 may be rotated by hand, but is preferably rotated using a tool. A suitable tool may include features for holding the connector in place while a lever is used to rotate the cam member 20.

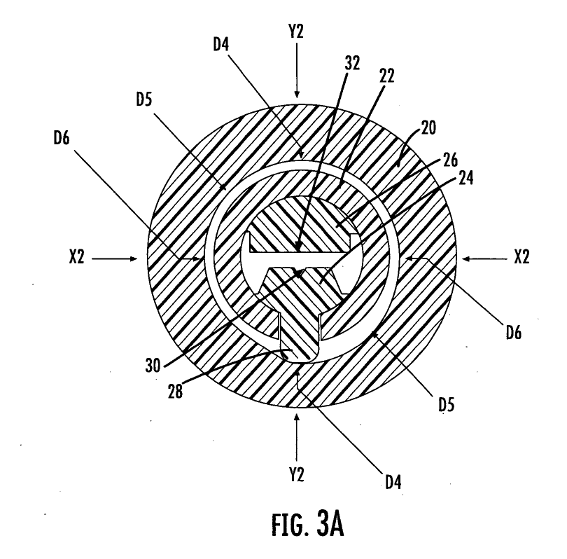

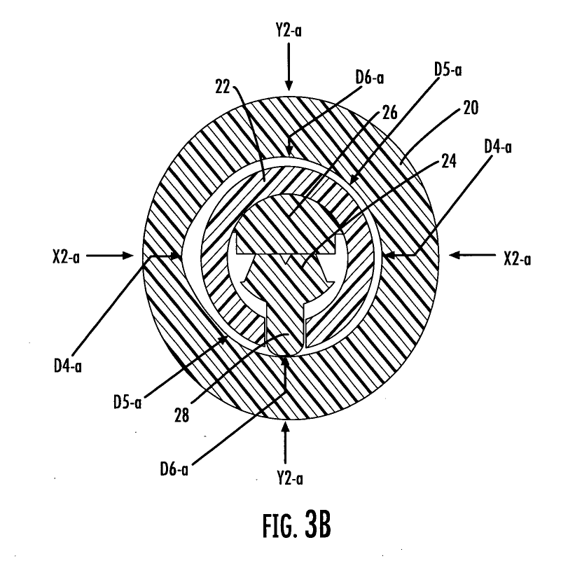

Referring to FIGS. 3A-3B, cross-sectional views of components affected by the rotation of the cam member 20 are shown. FIG. 3A shows the cam member 20 in an un-actuated position. FIG. 3B shows the cam member 20 rotated in the clockwise direction into the fully actuated or functional position. As shown herein, the cam member 20 rotates about 90 degrees around the longitudinal axis of the cam member 20 from the un-actuated position to the actuated position. However, in other embodiments the cam member 20 may rotate more or less than 90 degrees and may even move from the un-actuated position to the actuated position without rotating. These additional embodiments not shown and described herein are considered to be within the ordinary skill of the art and intended to be included within the scope of the appended claims. The cam member 20 defines a specific geometry that is used to apply a force to the keel 28 as the cam member 20 is rotated into the functional position. In a preferred embodiment, when the cam member 20 is in an un-actuated position, the cam member 20 defines three interior diameters: a first diameter D4 that is aligned with but does not interfere with the keel 28 of the first splice component 24; a second intermediate diameter D5 that is smaller than the first diameter D4; and a third diameter D6 that is smaller than the second intermediate diameter D5. Thus, D4>D5>D6. Preferably, there is a gradual decrease in the diameter of the interior of the cam member 20 from D4 to D6. The third diameter D6 is in contact with the keel 28 when the cam member 20 is rotated to the actuated or functional position.

Referring specifically to FIG. 3B, in the actuated position, the cam member 20 flexes, yet maintains the internal dimensional relationships where the first diameter D4-a is greater than the second diameter D5-a, and the second diameter D5-a is greater than the third diameter D6-a. Preferably, when the cam member 20 is in the actuated position, the largest diameter D4-a is significantly larger than the intermediate diameter D5-a, and the intermediate diameter D5-a is larger than the actuated diameter D6-a. In an alternative embodiment, in the actuated position, the second intermediate diameter D5-a may be equal to the third diameter D6-a. In the actuated or functional position, the cam member 20 may flex where the cam member 20 is in line with the splice keel 28, thus resulting in a lengthening of the cam member along one axis (e.g., y-axis) and a shortening of the cam member along another axis (e.g., x-axis), all the while maintaining the relationships between the three diameters. Comparing FIG. 3B to FIG. 3A, the width of the cam member 20 along the Y-axis may increase, resulting in the diameter Y2-a being greater than the diameter Y2, and the diameter X2 being greater than the diameter X2-a. In other words, Y2-a is greater than the width of the cam member 20 in-line with the keel 28 in the un-actuated position as shown in FIG. 3A at Y2. Thus, the flexing of the cam member 20 results in an elongation in one direction of the cam member 20 as the cam member 20 is rotated to the actuated or functional position. Maintaining the cam member 20 in the functional position is achieved by both the interference of the cam member 20 with the keel 28, along with the flexing of the cam member 20 which creates spring force or stored energy, helping to hold the assembly in the actuated position, and accommodating any differences in expansion of the assembly materials while undergoing temperature changes.

In one embodiment the cam member 20 may be flexible and resilient. In another embodiment, the cam member 20 may be deformable. With either cam member 20, in the actuated position, Y2-a is greater than Y2, and the D4>D5>D6 relationship is maintained. A resilient cam member 20 that is later uncammed will return to its original shape where Y2-a returns to the Y2 initial state and dimension. With a deformable cam member, after the assembly is uncammed, the Y2-a dimension may remain while still maintaining the D4>D5>D6 relationship.

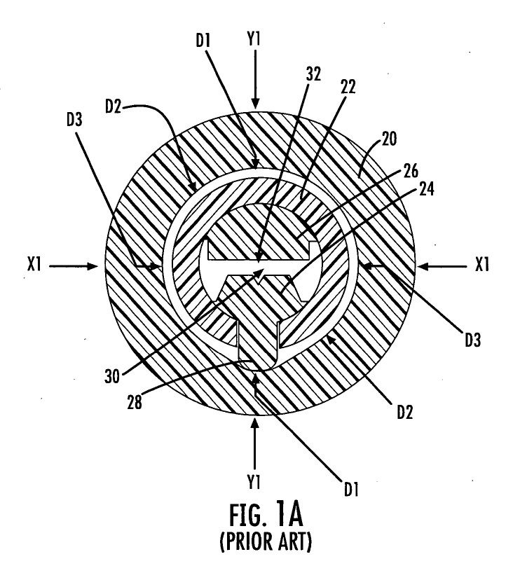

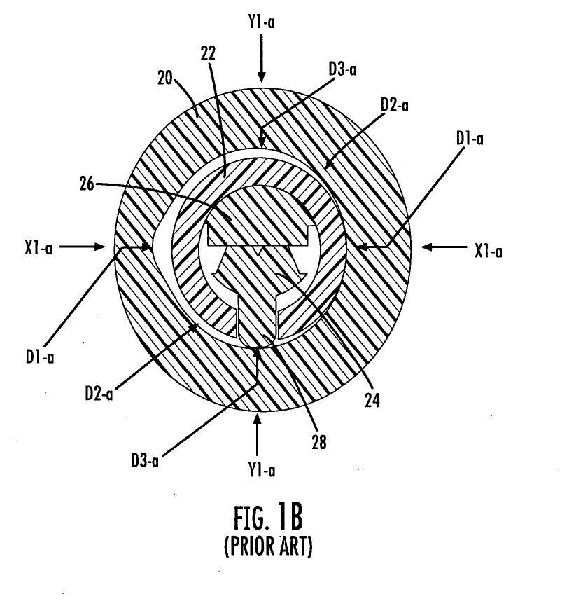

In contrast and referring again to FIGS. 1A-1B, the prior art cam member described above also defines three internal dimensions. In the un-actuated position, the first and largest cam circumferential dimension D1 is positioned over the keel, the second dimension D2 is the intermediate dimension, and the third dimension D3 will be positioned over the keel when the cam member is actuated. Thus, D1>D2>D3. However, when the prior art cam member is actuated, the cam circumferential dimension decreases to apply force to the keel, and in the fully actuated position the third circumferential dimension D3-a is smaller than the first dimension D1-a, but larger than the intermediate dimension D2-a. Thus, D1-a>D3-a>D2-a. With the cam member of the present invention, at the actuated position, D4-a remains larger than D5-a, and D5-a still remains larger than D6-a. Thus, D4-a>D5-a>D6-a. In the prior art, the resistance causes the cam member to flex, resulting in an altered configuration of the cam member internal dimensions in the functional position. In the present invention, the resistance may cause the cam member to flex during rotation to the functional position, however, the cam internal dimensional relationships in the functional position remain the same.

In an alternative embodiment (not shown), the cam member 20 may define an un-actuated diameter D1, and an actuated diameter D3, wherein the actuated diameter D3 is less than the un-actuated diameter D1 in both un-actuated and actuated positions of the cam member 20. The cam member 20 may also define an intermediate diameter D2 positioned between the un-actuated and the actuated diameters and having a diameter greater than both the un-actuated and actuated diameters. The cam member 20 may be flexible or rigid. The cam member 20 may be resilient and/or deformable. In an exemplary mechanical splice connector, the un-actuated diameter is positioned off of a keel of a splice component when the cam member is in the un-actuated position. As the cam member is rotated or moved to the actuated position, the intermediate diameter passes over the keel. In the fully actuated position, the actuated position is in line with the keel and the keel interferes with the interior surface of the cam member. In other embodiments, the un-actuated and actuated positions of the cam member have diameters that vary in size relative to each other, so long as the actuated position maintains the smallest diameter of the cam member in both the un-actuated and actuated positions.

In other embodiments, the external features of the cam member may be cylindrical as shown, or may include other application specific shapes (e.g., rectangular) in order to accommodate product size. The cam member of the present invention maintains a decreasing internal geometry from the largest distance in the un-actuated position to the smallest distance in the actuated position, without passing through a yet smaller intermediate position. The decreasing internal geometry may be smooth or stepped. The cam member external features may also be shaped to provide a gripping surface for applying a force from the tool. The material chosen for the cam member is preferably resilient and flexible in order to provide spring force to assist in holding the assembly in the functional position, while allowing the cam member to return to its original shape if it is un-actuated. In alternative embodiments, the cam member may be rigid, relying on component interference to hold the splice components in the functional position. In preferred embodiments, the cam member has the ability to maintain a smooth transition from the largest dimension in the un-actuated position to the smallest dimension in the actuated position, without passing through a yet smaller intermediate position.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A cam assembly for a fiber optic connector, comprising:
a flexible cam member defining a first un-actuated diameter, a second intermediate diameter and a third actuated diameter, wherein the first diameter is greater than the second diameter, and the second diameter is greater than the third diameter when the cam member is in both un-actuated and actuated positions.

2. The cam assembly according to claim 1, further comprising one or more splice components defining a keel that interferes with an interior surface of the cam member during cam member actuation.

3. The cam assembly according to claim 2, wherein the first diameter corresponds to a largest cam member interior dimension and is positioned off of the keel when the cam member is in an un-actuated position.

4. The cam assembly according to claim 2, wherein the third diameter corresponds to a smallest cam member interior dimension and is positioned over the keel when the cam member is in an actuated position.

5. The cam assembly according to claim 2, wherein the cam member applies a force to the keel as the cam member is rotated from the un-actuated to the actuated position.

6. The cam assembly according to claim 1, wherein there is a smooth transition in diameter from the first diameter to the third diameter.

7. The cam assembly according to claim 1, wherein the cam member is deformable.

8. The cam assembly according to claim 1, wherein the cam member is resilient.

9. The cam assembly according to claim 1, wherein the second diameter is equal to the third diameter when the cam member is in the actuated position.

10. The cam assembly according to claim 1, wherein the cam assembly is used in a mechanical splice fiber optic connector.

11. A cam assembly for a mechanical splice fiber optic connector, comprising:
a flexible cam member defining an interior surface and having a first interior diameter aligned off of a keel of a splice component when the cam member is in an un-actuated position, a second intermediate diameter that passes over the keel during rotation of the cam member between an un-actuated position and an actuated position, and a third interior diameter positioned over the keel when the cam member is in the actuated position; and
wherein the first interior diameter is greater than the second intermediate diameter, and the second intermediate diameter is greater than the third interior diameter when the cam member is in both un-actuated and actuated positions.

12. The cam assembly according to claim 11, wherein there is a smooth diameter transition on the interior surface of the cam member from the first diameter to the third diameter.

13. The cam assembly according to claim 11, wherein the cam member is sufficiently flexible to allow deformation during movement of the cam member between the un-actuated and the actuated positions.

14. The cam assembly according to claim 11, wherein the cam member is resilient.

15. The cam assembly according to claim 11, wherein the cam member is deformable.

16. The cam assembly according to claim 11, further comprising an additional splice component and a ferrule holder.

17. The cam assembly according to claim 11, wherein the interior surface of the cam member applies a force to the keel as the cam member is rotated from the un-actuated to the actuated position.

18. The cam assembly according to claim 11, wherein the second diameter is equal to the third diameter when the cam member is in the actuated position.

19. A flexible cam member for a fiber optic connector, wherein the cam member defines an interior surface whose diameter transitions from a cam member un-actuated position to an actuated position such that an interior diameter of the cam member un-actuated position is greater than the interior diameter of the cam member actuated position when the cam member is both actuated and un-actuated, and wherein an intermediate diameter of the cam member is less than the un-actuated diameter and greater than the actuated diameter in both cam member actuated and un-actuated positions.

20. A cam member for a fiber optic connector, wherein the cam member defines an un-actuated diameter and an actuated diameter, and wherein the un-actuated diameter is greater than the actuated diameter in both un-actuated and actuated positions of the cam member.

21. The cam member according to claim 20, wherein the cam member further defines an intermediate diameter that is greater than the un-actuated diameter.

22. The cam member according to claim 20, wherein the cam member further defines an intermediate diameter that is less than the un-actuated diameter.

23. The cam member according to claim 20, wherein the cam member is flexible.

24. The cam member according to claim 20, wherein the cam member is rigid.

25. The cam member according to claim 20, wherein the cam member is deformable.

26. The cam member according to claim 20, wherein in the un-actuated position of the cam member, the un-actuated diameter is positioned off of a keel of a splice component.

27. The cam member according to claim 20, wherein in the actuated position of the cam member, the actuated diameter is positioned in-line with and interfered with a keel of a splice component.
